(19) United States
(12) Patent Application Publication
(10) Pub. No.: US 2008/0179848 A1
(43) Pub. Date: Jul. 31, 2008

(54) ADJUSTABLE CARRYING DEVICE FOR A PEOPLE CARRIER, SUCH AS A PERAMBULATOR OR STROLLER

(75) Inventor: Jon Lake, Sunnyvale, CA (US)

Correspondence Address: CHRISTENSEN, O'CONNOR, JOHNSON, KINDNESS, PLLC, 1420 FIFTH AVENUE, SUITE 2800, SEATTLE, WA, 98101-2347, US

(73) Assignee: ILINKO LTD., Quarry Bay (HK)

(21) Appl. No.: 11/942,680

(22) Filed: Nov. 19, 2007

(30) Foreign Application Priority Data
Nov. 17, 2006 (DE) 20 2006 017 557.1

(51) Int. Cl. B62B 9/12

(52) U.S. Cl. 280/47.41

(57) ABSTRACT

ABSTRACT A people carrier and/or a person carrying device for a people carrier, wherein the person carrying device comprises a frame and is convertible from a seat configuration that supports a person in a substantially sitting position into a basket configuration that supports the person in a substantially lying position and/or vice-versa. An angle of inclination of a first frame component that creates a backrest in the seat configuration is adjustable relative to a main frame of the people carrier via a first turning unit. The frame further comprises a second frame component that creates a seat surface in the seat configuration, wherein an angle between the first and second frame components is adjustable, independently of the first turning unit, via a second turning unit that connects the first and second frame components. A third frame component may create a footrest at an adjustable angle via a third turning unit.

### BACKGROUND

A number of people carriers are known in the prior art, in particular in the form of perambulators or strollers.

U.S. Pat. No. 6,446,900 B1, for example, discloses a transport vehicle for a small child. The transport vehicle comprises a frame onto which a child carrier basket can be affixed in such a manner that it can be detached. In order to lock the carrier basket onto the frame, the carrier basket comprises a rod onto which a locking mechanism, which is arranged on the frame, can grip. For this purpose, the locking mechanism is supported in such a manner that it can be pivoted, and comprises recesses in order to retain the rod in a locking position of the locking device.

Furthermore, U.S. Pat. No. 6,286,844 B1 discloses a perambulator with a detachable seat. This perambulator contains a frame and a perambulator seat, which can be coupled to the frame by means of a generic connecting device. In order to lock the seat to the frame, the seat comprises a retaining pin which can grip into a hook of a locking device which interacts with the frame. In order to be able to release the hook grip on the pin, the seat comprises a release button which interacts with the hook when the seat is affixed to the frame. In order to unlock the seat from the frame, the release button is pressed down, as a result of which the grip of the hook on the pin is released.

DE 299 23 625 U1 discloses a buggy comprising a frame and a seat which can be affixed to said frame. By means of a plug-in and socket connection, the seat can be attached to the frame both in the direction of movement of the buggy and in the opposite direction. In addition, an angle of inclination of the otherwise static seat can be set relative to the frame by means of a joint.

However, a disadvantage of such locking devices for perambulators known in the prior art is that their operation is impeded depending on the operating position of the perambulator. In particular, with perambulators having a child carrying device that can be arranged both in the direction of travel and against the direction of travel, an operating device for a locking unit may be covered by other elements of the perambulator, such as frame elements, and thus be difficult to operate by a user.

In addition, perambulators in the prior art are known to have a child carrying device that can be converted from a seating configuration into a cot or basket configuration.

For example, a combination of a perambulator and a child carrying device is disclosed in U.S. Pat. No. 4,836,573. This combination comprises a frame of the perambulator and a generic child carrying device which is attached in a pivotal manner to the frame. In order to convert the child carrying device from a basket configuration, in which the child carrying device is essentially cuboid, into a seat configuration, said child carrying device is first pivoted in such a manner that a side wall of the child carrying device forms a seat surface, while a floor surface of the child carrying device adopts the function of a backrest. The additional three side walls of the child carrying device take the form of flexible side walls, so that the child carrying device can be converted from the cuboid form into a wedge form. However, a disadvantage with this combination is that the seat configuration is less comfortable for a child, since no adjustment of the different seat components in relation to each other is possible.

U.S. Pat. No. 5,833,261 discloses a footrest for a perambulator which can be moved between two positions. The perambulator comprises a frame onto which elements are affixed which enable the frame to retain a child carrying device in the form of a seat on the one hand, and in the form of a basket or cot on the other. For this purpose, on the one hand, a frame element which creates a backrest can be pivoted in such a manner that an angle between this element and an element which supports a seat surface can be altered. However, a disadvantage with this perambulator is that the frame cannot be adapted to different seat configurations. In particular, an angle of inclination of the seat surface cannot be altered.

Furthermore, canopy tops for perambulators are known in the prior art, in particular for protection against sun and rain.

DE 20 2005 010 099 U1, for example, discloses a perambulator which comprises a canopy top. The canopy top comprises two canopy top brackets onto which and between which a double-layered canopy top material is arranged. In order to tension the canopy top, the angle between the canopy top brackets is widened so that the material is tensioned, while in order to fold in the canopy top, the angle between the canopy top brackets is reduced and the canopy top material is folded. However, a disadvantage with this canopy top is that the canopy top material can be damaged when the canopy top is damp and folded together. Due to inadequate ventilation, mold or a similar substance can form on the canopy top material, or changes in the colour of the canopy top may occur.

Furthermore, US 2004110119266 A1 discloses a child's sports vehicle. This child's sports vehicle comprises a frame onto which a child carrying device can be affixed. The child carrying device comprises a canopy top. This canopy top takes the form of a hemisphere and is made of essentially inflexible material. The canopy top is affixed to the child carrying device so that it can be pivoted in such a manner that in a first configuration, it essentially covers the child carrying device, and in a second configuration, it is essentially arranged below the child carrying device. However, a disadvantage of this canopy top is that the canopy top cannot be altered in terms of its size, which makes the perambulator unwieldy, particularly during transportation.

### SUMMARY

Disclosed herein is a person carrying device for a people carrier that overcomes the disadvantages of the prior art and, in particular, provides greater variability when setting the person carrying device in a seat position. Furthermore, the present disclosure provides a people carrier, for example, in the form of a perambulator or stroller that overcomes the disadvantages of the prior art. The term “people carrier” as used herein should be understood to broadly include any form of vehicle capable of carrying a person of any age. The term “child carrier” is used herein synonymously with “people carrier” because such vehicles are typically used to transport children, though forms of such vehicles may be used to carry other persons of other ages, including those who are unable to transport themselves on foot. In various exemplary styles, a child carrier may be in the form of a perambulator or pram, a baby carriage, a carrycot, a stroller, a push chair, a buggy, etc.

In various embodiments, disclosed herein is a person carrying device for a people carrier, wherein the person carrying device comprises at least one frame and can be converted from a seat configuration in which the person is supported in an essentially sitting position into a basket configuration in which the person is supported in an essentially lying position and/or vice-versa. The angle of inclination of at least one first frame component, which creates at least one backrest in the seat configuration, is adjustable relative to at least one main frame of the people carrier via at least one first turning unit. The frame comprises at least one second frame component that creates at least one seat surface in the seat configuration. Also disclosed herein is a people carrier, in particular in the form of a perambulator or stroller that comprises a person carrying device as described herein.

In at least one embodiment, an angle between the first and the second frame component can be set regardless of the first turning unit via a second turning unit which connects the first and the second frame component.

Furthermore, in various embodiments, the frame comprises at least one third frame component that preferably creates a footrest in the seat configuration. The second and the third frame components are connected to each other via at least one third turning unit. In particular, at least one angle is adjustable between the second and the third frame component.

With the aforementioned alternatives, it can be provided that the person carrying device comprises, at least in the basket configuration, a substantially level lying surface that is formed by at least one part of the backrest and/or at least one part of the seat surface.

Furthermore, the person carrying device may be characterized by at least one bracket that is detachably connectable and/or formed as a single piece, at least in sections, with the first and/or the second frame component. The bracket may be used in the seat configuration as a safety bracket and/or used in the basket configuration as a carrying handle.

By means of the first turning unit, the angle between the first frame component and the main frame of a people carrier is adjustable continuously and/or in discrete stages. By means of the second turning unit, the angle between the first and the second frame component is adjustable continuously and/or in discrete stages. By means of the third turning unit, the angle between the second and the third frame components is adjustable continuously and/or in discrete stages.

In addition, by means of the first turning unit, the first frame component can be folded or rotated and, if appropriate, affixed relative to the main frame of a people carrier. By means of the second turning unit, the second frame component can be folded or rotated and, if appropriate, affixed relative to the first frame component. By means of the third turning unit, the third frame component can be folded or rotated and, if appropriate, affixed relative to the second frame component.

It is also suggested that the frame, in particular the first, second, or third frame component, is affixable to the main frame of a people carrier. In particular, the first, second, or third frame component is reversibly detachable to the main frame of a people by means of at least one connecting device.

An alternative embodiment provides at least one canopy top that is connectable or connected with the first, the second, and/or the third frame component and/or the first, the second, and/or the third turning unit, which preferably can be folded and/or pushed together in the manner of a telescope.

A person carrying device may comprise at least one first, second, or third frame component. Furthermore, the person carrying device may comprise a seat component that is detachable, affixable and/or which forms a single piece with the at least one first, second, or third frame component. The seat component preferably forms the seat surface and/or backrest, and may comprise at least one textile covering and/or at least one substantially fixed support and at least one shell component.

Particularly preferred is the fact that the second frame component may be formed in such a manner that it provides two side armrests, at least in the seat configuration.

In a further embodiment, the person carrying device comprises a combined turning unit that includes the first and second turning unit. It is also possible for the connecting device to comprise the first and the second turning unit, or complete the combined turning unit.

Also disclosed herein is a people carrier comprising a first component in the form of, or as part of, a main frame, and at least one person carrying device as a second component.

The people carrier may further comprise at least one connecting device that provides a reversibly detachable connection of at least one first component, in particular the main frame, and at least one person carrying device as the second component of the people carrier. The connecting device comprises at least one locking unit with at least one first locking element that interacts with the first component, at least one second locking element that interacts with the second component, and at least one actuation device. The locking unit comprises at least one locking position in which the first locking element and the second locking element mechanically engage with each other, and at least one unlocking position in which the mechanical engagement is released. The first and/or the second locking element is or are moveable by means of the actuation device in order to transfer the locking unit into the locking position and/or into the unlocking position.

The actuation device comprises at least one first actuation device and at least one second actuation device. When the first actuation device and/or the second actuation device is actuated, the first locking element can be moved equally from a locking into an unlocking position, or vice-versa, and/or when the first actuation device is actuated and/or when the second actuation device is actuated, the second locking element can be moved equally from a locking position into an unlocking position, or vice-versa. Preferably, the first and second actuation devices can be actuated from different, opposite sides of the connecting device.

Furthermore, the people carrier can comprise at least one wheel, at least one wheel carrier, at least one handle, at least one push rod, at least one auxiliary seat, at least one treadboard and/or at least one, preferably fold-in, canopy top. In particular, in the canopy top may be in the form of a covering hood, a canopy, a roof span, a marquise, a screen and/or a hood.

The connecting device may further comprise at least one first force generating unit, in particular comprising at least one spring unit, by way of which the first locking element can be forced into at least one locking position or at least one unlocking position. The connecting device may also comprise at least one second force generating unit, in particular comprising at least one spring unit, by way of which the second locking element can be forced in at least one locking position or at least one unlocking position.

The first component and the first locking element and/or the second component and the second locking element may be formed of a single piece, at least in sections.

In addition, the first locking element and/or the second locking element on the one hand, and the first actuation device and/or the second actuation device on the other hand may be formed of a single piece, at least in sections.

A people carrier can also comprise at least one canopy top to be at least partially tensioned over at least one opening of at least one person carrying device. The canopy top comprises at least two canopy top elements that are moveable relative to each other around at least one shared rotational axis. The canopy top elements comprise, in a first plane which contains the rotational axis and/or which runs essentially parallel to said rotational axis at least in sections, a substantially curve-shaped circumference form. In a second plane which runs essentially vertical to the rotational axis, the canopy top elements comprise, at least in sections, a circumference form which is substantially the form of a circle segment and/or a wedge form. The dimensions of at least one first canopy top element and at least one second canopy top element differ from each other in the first plane in such a manner that the first and the second canopy top element can be pushed into each other, in a telescopic manner, by rotating them around the rotational axis.

The first and/or the second canopy top element in the first plane may comprise at least one circumference form which is, at least in sections, circular, elliptical, parabolic, and/or polygonal, e.g., triangular and/or rectangular.

While embodiments are described herein in the context of a child carrier, such as a perambulator, the invention is not limited to the precise forms disclosed. The principles of the invention described herein are equally applicable to a sports vehicle, a buggy, a perambulator for the transportation of at least two children, a disabled person's buggy and/or a disabled person's vehicle, among other forms of vehicles for carrying people of any age.

As shown herein, a person carrying device for a people carrier, such as a child carrying device for a perambulator, can be designed in such a manner that they can on the one hand be converted between a seat configuration and a basket or cot configuration, while on the other hand the person carrying device can be adapted to the relevant conditions in the best possible manner. In particular, the seat configuration of the person carrying device can be adjusted as variably as possible. This is achieved by means of the fact that the person carrying device, which in the seat configuration acts as a backrest, is essentially affixable to a main frame of the people carrier in such a manner that it can be pivoted. This makes it possible to set any angle of inclination required in the seat configuration. By means of further rotary connection of a second component that acts as a seat surface in the seat configuration, any angle of inclination required can be set between the backrest and the seat surface, which makes a significant contribution to the comfort of the seat. Finally, a third component of the person carrying device which acts as a footrest is affixed in such a manner that it can be pivoted to the second component. This makes it possible in the seat configuration to adjust the angle of the footrest to the respective angle of inclination of the seat or of the backrest, and to set a relative angle between the backrest and a seat surface.

Furthermore, with people carriers according to this embodiment of the invention, only two further components are required in order to obtain a fully functioning perambulator, with which both transportation in a lying position and transportation in a sitting position is possible. The child carrying device can in both cases be attached in such a manner that it faces away from the person pushing the carriage, if desired. With perambulators in the prior art, at least three individual components are regularly required in order to obtain this functional versatility. This entails higher costs and greater space requirements.

The foregoing summary introduces a selection of concepts in a simplified form that are further described below in the Detailed Description. This summary is not intended to specify key features of the claimed subject matter, nor is it intended to be used to determine the scope of the claimed subject matter.

### DESCRIPTION OF THE DRAWINGS

Further features and advantages of the invention are described below using examples, in which the exemplary embodiments of the invention are explained with reference to schematic drawings, in which:

FIG. 1 shows a perambulator according to one embodiment of the invention with a main body and a child carrying device;

FIG. 2 shows the perambulator shown in FIG. 1, wherein the child carrying device is covered with corresponding textile elements and further comprises a canopy top;

FIG. 3 shows an enlarged detailed view of the portion A of FIG. 1, in which a connecting device is shown;

FIG. 4a shows a cross-sectional view of the connecting device shown in FIG. 3 in a locked position;

FIG. 4b shows a cross-sectional view of the connecting device shown in FIG. 3 in an unlocked position;

FIG. 4c shows a cross-sectional view of the connecting device shown in FIG. 3 in an unlocked position;

FIG. 5 shows a perspective view of the perambulator in FIG. 1 following a release of the connection between the child carrying device and the main body;

FIG. 6a shows a side view of the perambulator shown in FIG. 1, in which the child carrying device is in a seat configuration;

FIG. 6b shows a side view of the perambulator shown in FIG. 6a after the child carrying device has been pivoted around a first rotational axis for transfer into a basket configuration;

FIG. 6c shows a side view of the perambulator shown in FIG. 6b, in which a component of the child carrying device is pivoted around a second rotational axis for the conversion of said child carrying device into a basket configuration;

FIG. 6d shows a side view of the perambulator shown in FIG. 6c, after a third component of the child carrying device has been pivoted around a third rotational axis for the conversion of said child carrying device into a basket configuration;

FIG. 7a shows a perspective view of a perambulator according to an embodiment of the invention comprising a further embodiment of a canopy top in an unfolded state;

FIG. 7b shows a cross-sectional view of the canopy top shown in FIG. 7a;

FIG. 7c shows a perspective view of the perambulator shown in FIG. 7a with the canopy top in a semi-folded state;

FIG. 7d shows a cross-sectional view of the canopy top shown in FIG. 7c;

FIG. 7e shows a perspective view of the perambulator shown in FIG. 7a with the canopy top in a folded-in state;

FIG. 7f shows a cross-sectional view of the canopy top shown in FIG. 7e;

FIG. 8a shows a perambulator comprising a child carrying device in accordance with FIG. 6a with a canopy top in an unfolded state;

FIG. 8b shows a side view of the perambulator shown in FIG. 8a with the canopy top in a folded-in state;

FIG. 9a shows a side view of a perambulator comprising a child carrying device in accordance with FIG. 6d in a basket configuration with a canopy top in an unfolded state, and

FIG. 9b shows a side view of the perambulator shown in FIG. 9a with the canopy top in a folded state.

### DETAILED DESCRIPTION

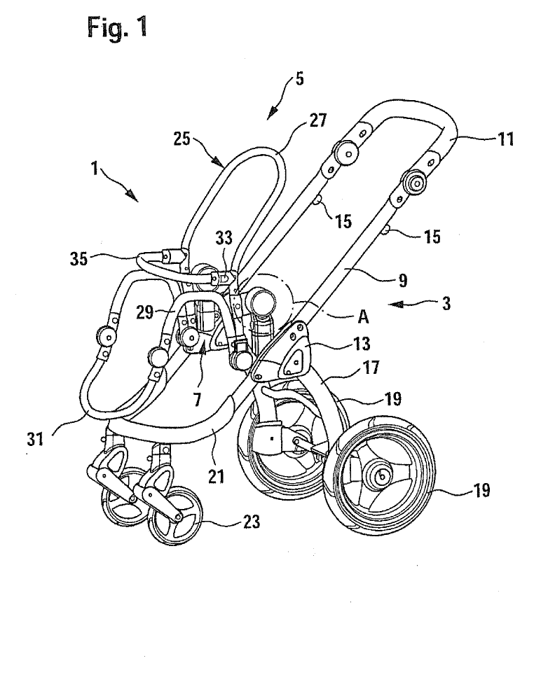

FIG. 1 shows a perspective view of one embodiment of a people carrier in the form of a perambulator 1. The perambulator 1 comprises a main body or frame 3 and a person carrying device in the form of a child carrying device 5. Here, it should be noted that in FIG. 1 only a basic form of the child carrying device 5 is shown. The child carrying device 5 is detachably connected to the frame 3 via a connecting device 7.

The frame 3 comprises, for example, a push rod 9 with a handle 11. Via a folding mechanism 13, which can be unlocked via a release lever 15, the push rod 9 is connected with a rear wheel carrier 17 on which rear wheels 19 are attached, and a front wheel carrier 21 to which front wheels 23 are applied. The child carrying device 5 comprises, as will be explained in greater detail below, a frame 25 that comprises a first frame component 27, a second frame component 29 and a third frame component 31.

In FIG. 1, the child carrying device 5 is in a seat configuration, in which the first frame component 27 creates a backrest of a seat, the second frame component 29 essentially creates a seat surface or a side guide element or an armrest for a child which is positioned in the child carrying device 5, and the third frame component 31 creates a footrest. As can be seen from FIG. 1, a bracket 35 can be detachably affixed to the frame 25 by means of a connecting unit 33. This bracket 35 prevents the child from falling out of the child carrying device 5 shown in FIG. 1. In other words, the bracket 35 acts as a safety bracket, while the bracket 35, as will be explained in greater detail below, can be also used in a basket configuration of the child carrying device 5 as a carrying bracket.

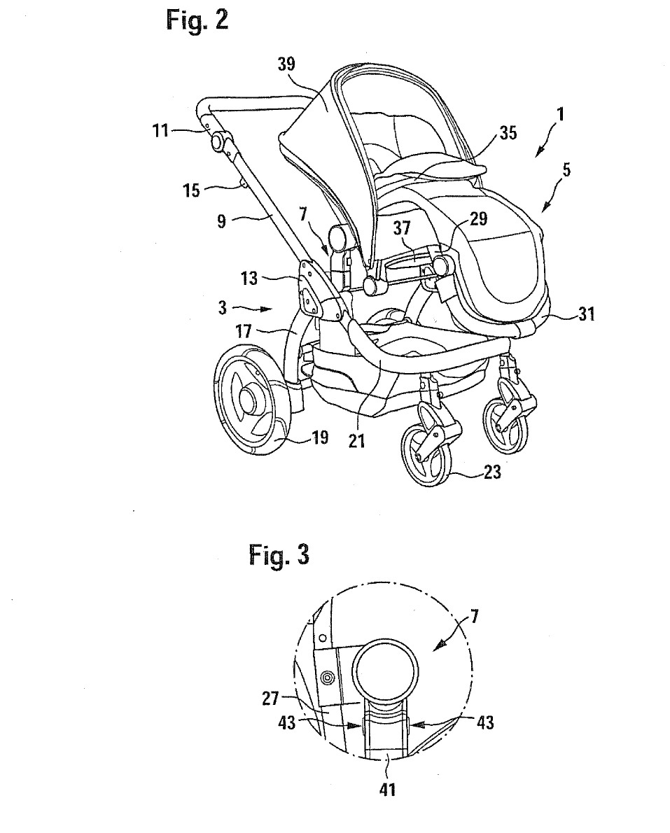

FIG. 2 shows a side view of the perambulator 1 shown in FIG. 1. In contrast to FIG. 1, the frame 25 of the child carrying device 5 is covered with a fabric cover 37. As a result, a corresponding seat surface and backrest are provided for a child to be positioned in the child carrying device 5. Although in FIG. 2, the frame 25 is covered with a textile material, the invention is not restricted to such an embodiment. In other embodiments, fixed or inflexible elements, such as hard shell elements, can be attached to the frame 25, in particular the frame components 27, 29, 31, in order to provide a backrest, a seat surface and/or a footrest. Furthermore, in FIG. 2, a canopy top 39, which in FIG. 2 is in a folded-in state, can be arranged on the child carrying device 5.

The structure and functionality of the connecting device 7 will now be explained in detail below. Although in the embodiment shown, the connecting device 7 is used to connect the child carrying device 5 with the frame 3, the present invention is not restricted to this application. By way of the connecting device 7 shown, different components of a people carrier such as the perambulator 1 can be detachably connected with each other. Thus, for example, using a connecting unit 33 that comprises the features of the connecting device 7, the canopy top 39 could be connected by means of a corresponding connecting device 7 with the child carrying device 5. Alternatively, or in addition, further components such as an auxiliary seat or a treadboard could be connected with the frame 3 by means of such a connecting device 7.

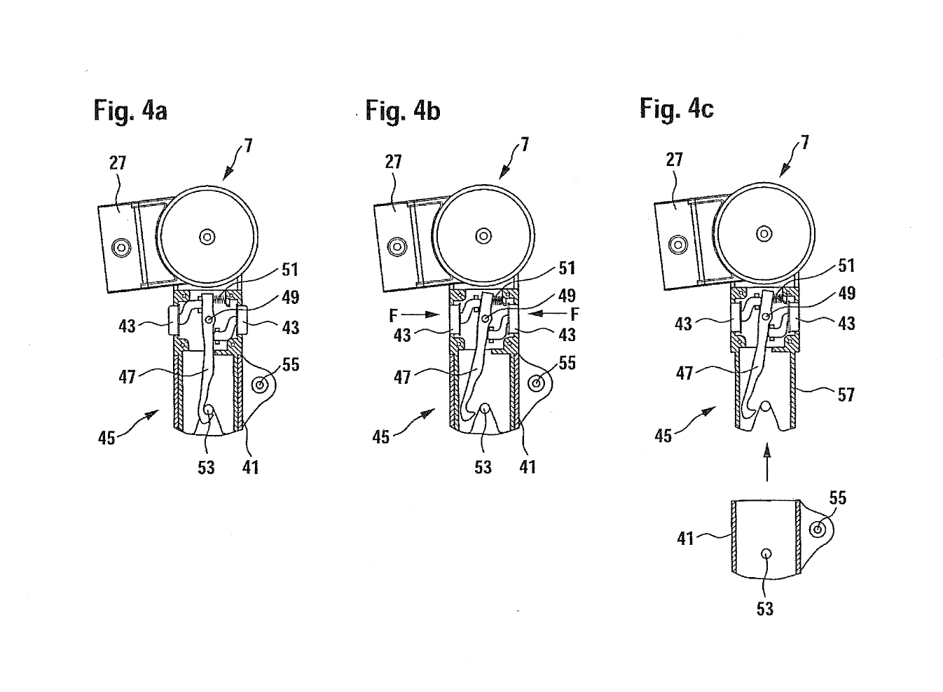

As can be seen in FIG. 3, the connecting device 7 is used in the embodiment shown to detachably connect the child carrying device 5 to the frame 3. In particular, the child carrying device 5 is connected to the first frame component 27 by means of a connecting element 41. In order to prevent the child carrying device 5 from inadvertently becoming detached from the frame 3, the connecting device 7 comprises a locking unit 45 which subsequently will be described in greater detail. The locking unit 45 comprises actuation devices in the form of two push-buttons 43, wherein a first actuation device is arranged in a direction of travel of the people carrier, while the second actuation device is arranged against the direction of travel. As a result of an actuation or pressing down of at least one of the push-buttons 43, the locking unit 45 can be transferred from a locking position to an unlocking position. If the locking unit 45 is in an unlocking position, the child carrying device 5 can be detached from the frame 3.

The perambulator 1 shown in FIG. 1 comprises two connecting devices 7, with one respectively on each side of the child carrying device 5. Both connecting devices 7 comprise a corresponding locking unit 45. In an alternative embodiment, it can also be provided that only one of the connecting devices 7 comprises a corresponding locking unit 45.

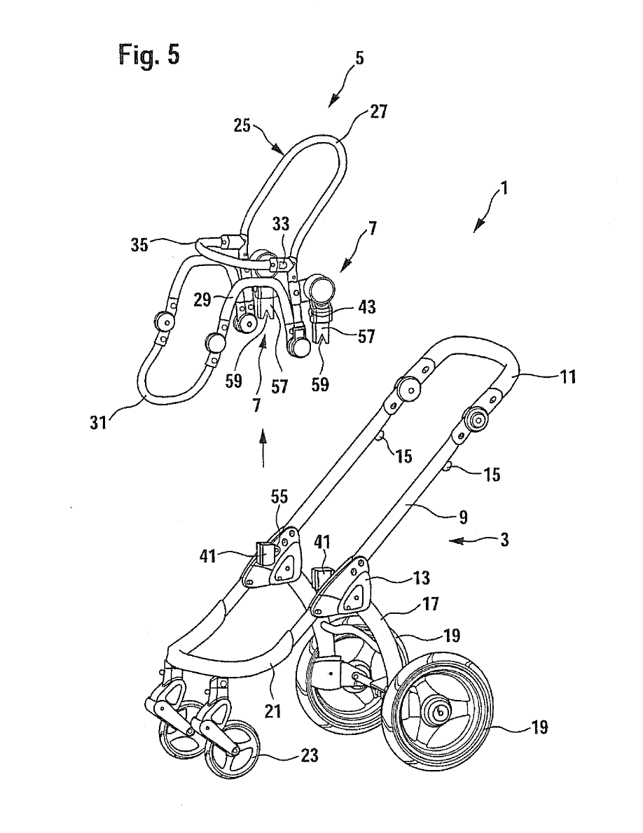

FIG. 4a shows a cross-section view through the connecting device 7 shown in FIG. 3. The connecting device 7 comprises a locking unit 45. The locking unit 45 comprises a first locking element in the form of a latch hook 47. The latch hook 47 is supported around an axis 49 in such a manner that it can be pivoted. Furthermore, the locking unit 45 comprises a force generation unit in the form of a spring unit 51. Via the spring unit 51, the latch hook 47 is forced into the position shown in FIG. 4a. The locking unit 45 furthermore comprises a second locking element in the form of a pin 53. In this embodiment, the pin 53 is designed as a single piece with the connecting element 41, which is connectable with the frame 3 by means of a screw connection 55. In the configuration shown in FIG. 4a, the locking unit 45 is in a locking position. In particular, the latch hook 47 engages the pin 53, so that the child carrying device 5 cannot be detached from the connecting element 41.

In order to remove the child carrying device 5 from the frame 3, the locking unit 45 is transferred to an unlocking position, as it is shown in particular in FIG. 4b. In order to transfer the locking unit 45 into the unlocking position, the latch hook 47 is transferred from the locking position shown in FIG. 4a to the unlocking position shown in FIG. 4b, in which it no longer engages the pin 53. For this purpose, one of the push-buttons 43 is subjected to a force F by a user, as a result of which the latch hook 47 revolves around the axis 49 against the force of the spring unit 51. Although, as is shown in FIG. 4b, both push-buttons 43 can be pressed simultaneously to transfer the locking unit 45 from the locking position into the unlocking position, an actuation of just one push-button 43 is sufficient. Thus, a single actuation of one of the push-buttons 43, regardless which push-button 43 is actuated, leads to an identical or equal movement of the latch hook 47, i.e., a revolution of the latch hook 47 in a clockwise direction around the axis 49 shown in FIG. 4a and FIG. 4b.

The child carrying device 5 is designed in such a manner that the child carrying device can be arranged to face the direction of travel and/or against the direction of travel of the perambulator 1. Due to the geometry of the frame 3 and different additional elements that can be attached to the frame 3 and the child carrying device 5, it may be the case that one of the actuation devices or push-buttons 43 is not easily accessible to the user, while the other push-button 43 is easily accessible. The locking unit 45 thus has the advantage that an uncomplicated unlocking of the locking device 7 is possible in every configuration of the perambulator 1. This advantage is achieved by means of the fact that the actuation devices mechanically interact with one of the locking elements, in this case, with the first locking element in the form of the latch hook 47, in such a manner that an actuation of one of the actuation devices leads to a movement of the locking element in the same direction, regardless of the actuation device that is used.

Following a transfer of the locking unit 45 into an unlocking position, the child carrying device 5 can be detached from the frame 3. As can be seen in FIG. 4c, for this purpose, a shaft 57 is pulled out of the connecting element 41. To achieve a state in which the pin 53 is set in a specified position relative to the latch hook 47 when the child carrying device 5 is attached to the frame 3, the shaft 57 essentially comprises a V-shaped recess 59 into which the pin 53 slides when the shaft 57 is inserted into the connecting element 41.

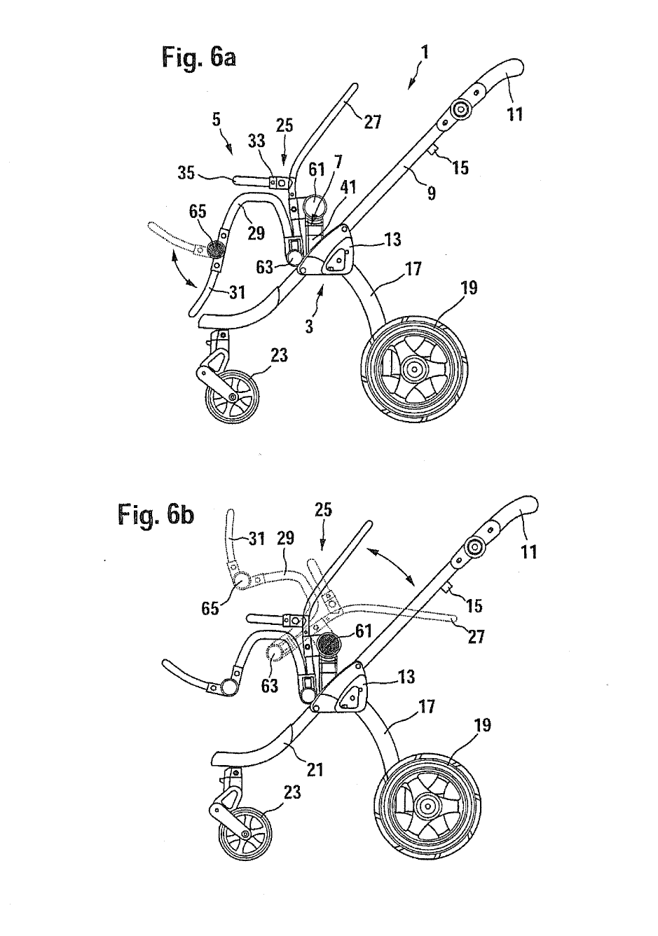

In FIG. 5, the perambulator 1 from FIG. 1 is shown after the connection between the child carrying device 5 and the frame 3 has been released by actuating the connecting device 7 and by lifting the child carrying device 5.

In the following, the setting options for the child carrying device 5 will be explained, in order to illustrate the variability of this child carrying device 5. In particular, it will be explained how the child carrying device 5 can be converted from the seat configuration shown in FIG. 1 to a basket or cot configuration.

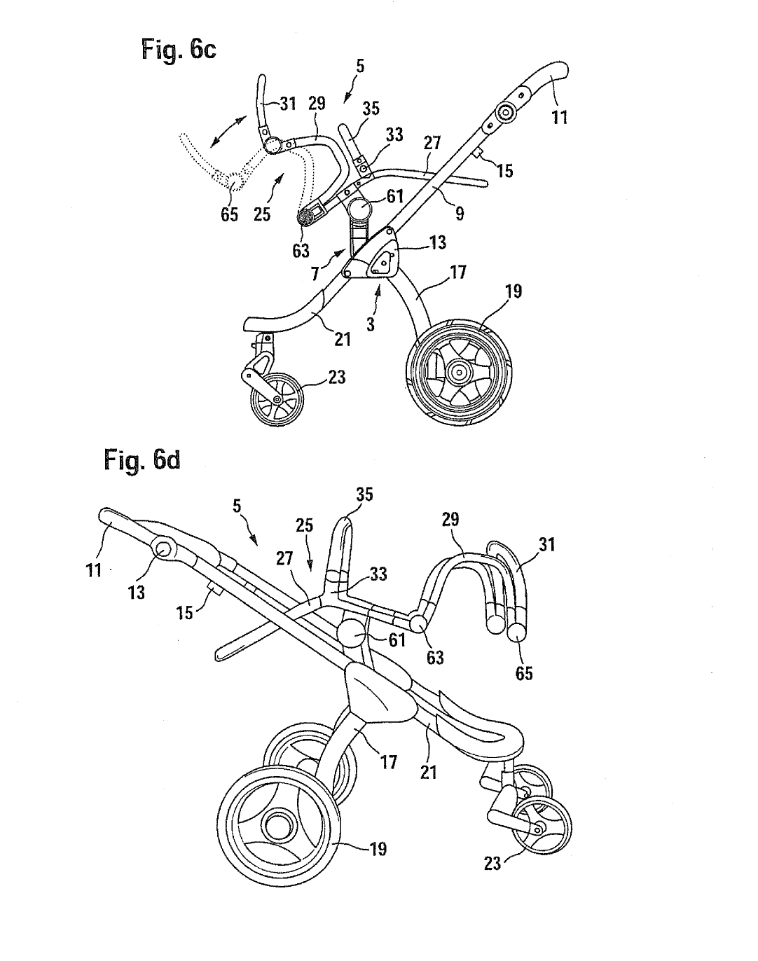

As can in particular be seen in FIG. 6a, the child carrying device 5 comprises a first turning unit 61 by way of which the first frame component 27 is connected to the frame 3 via the connecting device 7 in such a manner that it can be pivoted. By way of the first turning unit 61, an angle can be set between the frame 3 and the first frame component 27 or the entire child carrying device 5. Here, the setting of the angle can be made continuously or altered in discrete stages via the turning unit 61. In particular, the first turning unit 61 can comprise different latch positions for this purpose, in which the first turning unit 61 can preferably be set.

The second frame component 29 is connected to the first frame component 27 via a second turning unit 63. The second turning unit 63 makes it possible to alter an angle between the first frame component 27 and the second frame component 29 continuously and/or in discrete stages. In the seat configuration shown in FIG. 6a of the child carrying device 5, the first frame component 27 creates a backrest (not shown), while the second frame component 29 creates a seat surface (not shown). The backrest and seat surface are produced by attaching a textile covering or corresponding seat shell components to the frame 25. In this manner, the second turning unit 63 makes it possible to set an angle between the backrest and the seat surface in the seat configuration shown in FIG. 6a.

Finally, the third frame component 31 which in particular acts as a footrest is connected to the second frame component 29 via a third turning unit 65. In the seat configuration shown in FIG. 6a, the third turning unit 65 enables a continuous setting and/or a setting in discrete stages, of a foot rest relative to the seat surface which is created by the second frame component 29. Thus, the feet of a child sitting in the child carrying device 5 can be either raised up or left hanging down. Preferably, at least one of the turning units 61, 63, 65 comprises at least one operating element by way of which the corresponding turning units 61, 63, 65 can be locked in a required position. Alternatively, a corresponding lock can be modified in order to adjust the relative positions of the frame components 27, 29, 31 to each other, or to adjust the frame 25 to the frame 3 of the perambulator 1.

It will now be explained how the child carrying device 5 can be converted from the seat configuration shown in FIG. 6a to a basket or cot configuration. According to FIG. 6b, for this purpose, the frame 25 of the child carrying device 5 is initially tipped relative to the frame 3 of the perambulator 1 by means of the first turning unit 61. In particular, a backrest created by the first frame component 27 is brought into a position which is substantially parallel to a surface on which the perambulator 1 is arranged.

As a result of a subsequent actuation of the second turning unit 63, the second frame component 29 can then, for example, be pivoted, together with the third frame component 31, relative to the first frame component 27 as shown in FIG. 6c. In particular, the frame 25 can be brought into a configuration in which a surface of the backrest created by the first frame component 27 is positioned at an angle of 180° to the seat surface created by the second frame component 29, so that a lying surface is formed for a child carried in the child carrying device 5.

The third frame component 31 can be adjusted relative to the second frame component 29 via the third turning device 65, in order complete the basket configuration as shown in FIG. 6d.

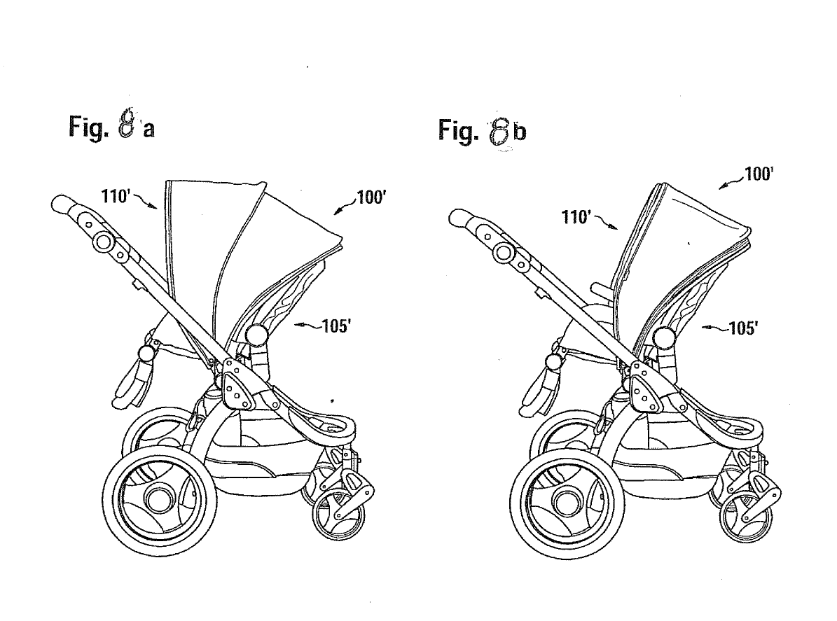

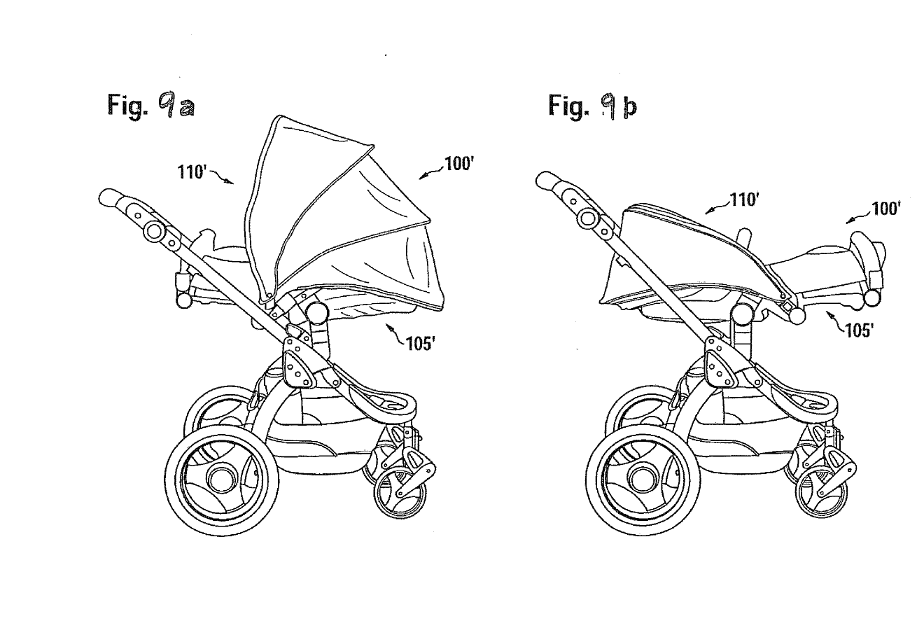

Thus, the child carrying device 5 provides maximum flexibility with a greater degree of comfort for a child carried in the child carrying device or for a user. The first turning unit 61 enables a complete tipping of the child carrying device 5, in particular when said child carrying device is in a seat configuration as shown in FIG. 6a or FIG. 8a and FIG. 8b, but also when it is in the basket or cot configuration as shown in FIG. 6d or FIG. 9a and FIG. 9b. In addition, the second turning unit 63 makes it possible, when the child carrying device 5 is in the seat configuration, to set an angle between a backrest and a seat surface of the child carrying device 5. Finally, the third turning unit 65 makes it possible to adapt the position of a footrest in any way required, and at the same time for the footrest to act as an end wall for the child carrying device 5 in a basket configuration. As can be seen in particular in FIG. 6d and FIG. 9b, the bracket 35 of the child carrying device 5 can be used in the basket configuration of said device as a carrying handle to lift the child carrying device 5 from the frame 3 after unlocking the connecting unit 7.

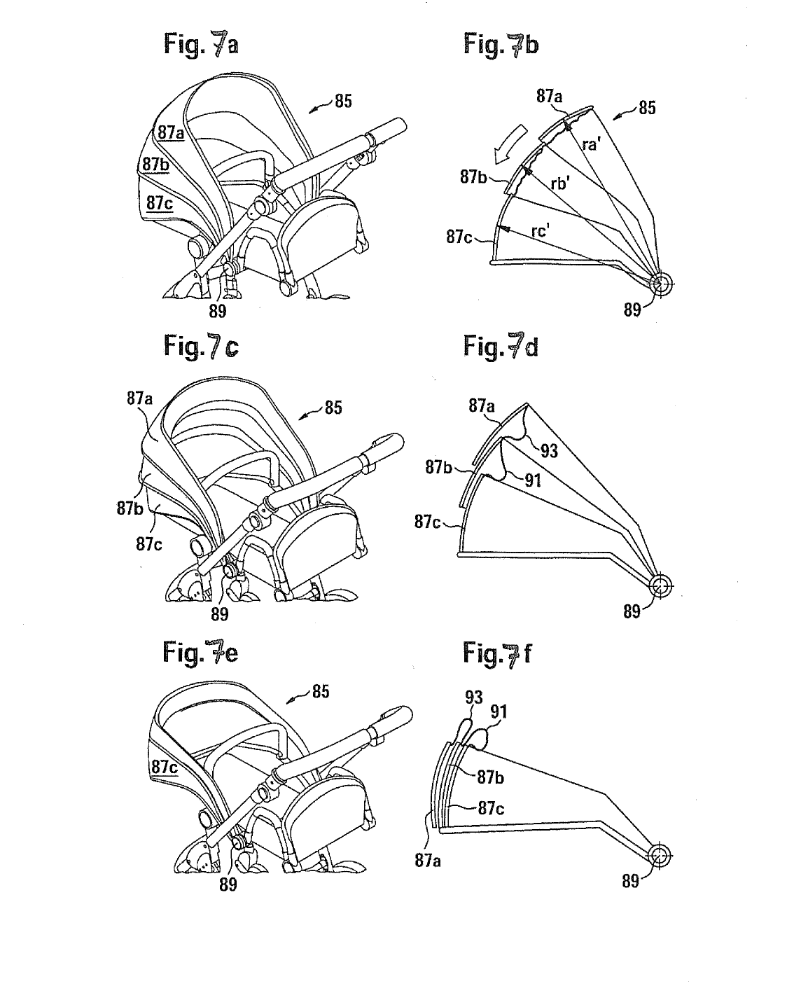

In FIG. 7a to FIG. 7f, a further embodiment of a canopy top 85 is shown, which can be attached to the perambulator 1. According to FIG. 7a and FIG. 7b, the canopy top 85 also comprises canopy top elements 87a, 87b, and 87c. In contrast to the canopy top 75, the canopy top elements 87a, 87b, 87c do not comprise canopy top brackets which are covered with a canopy top material, but are essentially formed as single-piece elements. In a similar manner to the canopy top elements 77a, 77b, 77c, the canopy top elements 87a, 87b, 87c are arranged in a substantially curved form on an axis 89, around which the canopy top elements 87a, 87b, 87c can be pivoted, wherein the radii rₐ′, r_{b}′, r_{c}′ differ in size and rₐ′>r_{b}′>r_{c}′ applies in particular. As a result, the canopy top elements 87a, 87b, 87c, as can particularly be seen in FIG. 7b, FIG. 7d, FIG. 7f, can be pushed or moved into each other in the manner of a telescope or fan. Furthermore, as can particularly be seen in FIG. 7f, when the canopy top 85 is folded together, the canopy top elements 87a, 87b, 87c remain at a distance from each other in order to enable sufficient ventilation between the canopy top elements 87a, 87b, 87c. In contrast to the canopy top 75, corresponding carrier devices via which the respective canopy top elements are mechanically coupled to each other according to a pre-specified scale of travel when the canopy top 85 is folded out, are not arranged in the region of the rotational axis 89, but are set at a distance from the rotational axis 89. The carrier device 91, 93, can be an inner lining of the canopy top 85.

In FIGS. 8a, 8b and FIGS. 9a, 9b, perambulators 100′ are shown in different configurations with respective child carrying devices 105′. FIG. 8a shows a perambulator 100 that comprises a child carrying device in the form of a cot 105 on which a canopy top 110 in an unfolded state is arranged. In FIG. 8a to FIG. 9b, the perambulator 100′ comprises a transformable child carrying device 105′ that is similar to the child carrying device 5. In FIG. 8a and FIG. 8b, the child carrying device 105′ is in a seat configuration, wherein a canopy top 110′ is arranged on the child carrying device 105′ in a partially unfolded state and while the canopy top 110′ in FIG. 8b is folded together. In contrast, the child carrying device 105′ shown in FIG. 9a and FIG. 9b is unfolded in a cot or basket configuration, wherein in FIG. 9a, the canopy top 110′ is unfolded, while in FIG. 9b, it is folded together.

In particular with regard to the configuration of a cover, it should be noted that the canopy tops disclosed herein are not restricted to a single configuration in which individual canopy top elements are supported around a shared rotational axis in a manner that they can be pivoted. It can also be provided that the canopy top elements are not designed in the form of spheres, ellipses or disc segments, but can take the form of tube segments that can be moved along a longitudinal axis, wherein the canopy top segments can be pushed or moved into each other in the manner of a telescope.

The features of the invention disclosed in the above description, in the claims and in the drawings can in their different embodiments be present both individually and in any combination required in order to realise the invention.

While illustrative embodiments have been illustrated and described, it will be appreciated that various changes can be made therein without departing from the spirit and scope of the invention.

What is claimed is:

1. A person carrying device for a people carrier, wherein the person carrying device comprises at least one frame and is convertible from a seat configuration in which a person can be supported in a substantially sitting position into a basket configuration in which the person can be supported in a substantially lying position and/or vice-versa, wherein an angle of inclination of at least one first frame component that creates at least one backrest in the seat configuration is adjustable relative to at least one main frame of the people carrier via at least one first turning unit, and wherein the frame further comprises at least one second frame component that creates at least one seat surface in the seat configuration, and wherein at least one angle between the first frame component and the second frame component is adjustable, independently of the first turning unit, via a second turning unit that connects the first frame component and the second frame component.

2. A person carrying device according to claim 1, wherein the frame comprises at least one third frame component, and wherein the second frame component and the third frame component are connected to each other via at least one third turning unit, in which at least one angle between the second frame component and the third frame component is adjustable.

3. A person carrying device according to claim 1, wherein the frame comprises at least one third frame component that creates a footrest.

4. A person carrying device according to claim 1, wherein the person carrying device comprises at least in the basket configuration a substantially level lying surface that is formed by at least one part of the backrest and/or at least one part of the seat surface.

5. A person carrying device according to claim 1, further comprising at least one bracket that is connectable with the first frame component and/or the second frame component and/or is formed as a single piece, at least in sections, with the first and/or the second frame component, wherein the bracket is useable in the seat configuration as a safety bracket and/or is useable in the basket configuration as a carrying handle.

6. A person carrying device according to claim 1, wherein by means of the first turning unit the angle between the first frame component and the main frame of a people carrier is adjustable continuously and/or in discrete stages, by means of the second turning unit the angle between the first and the second frame component is adjustable continuously and/or in discrete stages, and/or by means of the third turning unit the angle between the second and the third frame component is adjustable continuously and/or in discrete stages.

7. A person carrying device according to claim 1, wherein the first, second or third frame component is affixable or reversibly detachable by means of at least one connecting device to the main frame of the people carrier.

8. A person carrying device according to claim 1, further comprising at least one canopy top that is connectable or connected to the first, second and/or third frame component and/or the first, second and/or third turning unit.

9. A person carrying device according to claim 1, wherein the first, second or third frame component or a seat component is reversibly detachable, affixable and/or forms a single piece with at least one first, second or third frame component that forms the seat surface and/or the backrest.

10. A person carrying device according to claim 1, wherein the second frame component is formed in such a manner that it provides two side armrests, at least in the seat configuration.

11. A person carrying device according to claim 1, further comprising a combined turning unit comprising the first and second turning unit.

12. A people carrier comprising a first component in the form of or as part of a main frame and at least one person carrying device according to any one of claims 1 to 11 as a second component.

13. A people carrier according to claim 12, further comprising at least one connecting device for reversibly detachably connecting the at least one first component in the form of or as part of the main frame and the at least one person carrying device as the second component of the people carrier, wherein the connecting device comprises at least one locking unit with at least one first locking element that interacts with the first component, at least one second locking element which interacts with the second component, and at least one actuation device, wherein the locking unit comprises at least one locking position in which the first locking element and the second locking element mechanically grip each other and at least one unlocking position in which the mechanical grip is released, wherein the first and/or the second locking element is or are moveable by means of the actuation device in order to transfer the locking unit into the locking position and/or into the unlocking position, wherein the actuation device comprises at least one first actuation device and at least one second actuation device and by way of an actuation of the first actuation device and/or an actuation of the second actuation device, the first locking element is equally moveable from a locking position into an unlocking position or vice-versa, and/or by way of an actuation of the first actuation device and/or an actuation of the second actuation device, the second locking element is equally moveable from a locking position into an unlocking position or vice-versa, and wherein the first and the second actuation device can be actuated from different sides of the connecting device.

14. A people carrier according to claim 13, wherein the connecting device comprises a first and second turning unit or a combined turning unit.

15. A people carrier according to claim 12, further comprising at least one wheel, at least one wheel carrier, at least one handle, at least one push rod, at least one auxiliary seat, at least one treadboard and/or at least one canopy top, a canopy, a roof span, a marquise, a screen and/or a hood.

16. A people carrier according to claim 13, wherein the connecting device comprises at least one first force generating unit by way of which the first locking element is forcible into at least one locking position or at least one unlocking position, and/or at least one second force generating unit by way of which the second locking element is forcible in to at least one locking position or at least one unlocking position.

17. A people carrier according to claim 12 in the form of a perambulator or in the form of a sports vehicle, a buggy, a perambulator for the transportation of at least two children, a disabled person's buggy and/or a disabled person's vehicle.
